(19) United States
(12) Patent Application Publication
(10) Pub. No.: US 2025/0257440 A1
(43) Pub. Date: Aug. 14, 2025

(54) COATING COMPRISING A RARE EARTH MONOSILICATE AND A RARE EARTH DISILICATE AND METHOD OF MANUFACTURE THEREOF

(71) Applicant: VALORBEC, SOCIÉTÉ EN COMMANDITE, Québec (CA)

(72) Inventors: Christian MOREAU, Boucherville (CA); Farzam ARHAMI, Mont-Royal (CA)

(21) Appl. No.: 18/858,049

(22) PCT Filed: May 3, 2023
(86) PCT No.: PCT/CA2023/050600

§ 371 Date: Oct. 18, 2024

Related U.S. Application Data
(60) Provisional application No. 63/337,696, filed on May 3, 2022.
(60) Provisional application No. 63/366,873, filed on Jun. 23, 2022.

(51) Int. Cl. C23C 4/11; C04B 41/45; C04B 41/87; C23C 4/02; C23C 4/134; C23C 4/18

(52) U.S. Cl. CPC C23C 4/11; C04B 41/4527; C04B 41/87; C23C 4/02; C23C 4/134; C23C 4/18

(57) ABSTRACT

We provide a coating as an environmental barrier coating, for example on a ceramic matrix composite, e.g., in a gas turbine. The coating comprises a rare earth monosilicate and a rare earth disilicate in a weight ratio of at least about 70:30. The coating is at least 60% crystalline, has a porosity of at most about 40%, and is free of through-thickness cracks. We also provide a method of manufacturing this coating comprising heating a substrate to at least about 500° C., and depositing the coating by atmospheric plasma spraying ytterbium disilicate particles on the heated substrate, wherein the atmospheric plasma spraying is performed with a plasma spray torch operated at an operating power of at least 60 kW.

### CROSS REFERENCE TO RELATED APPLICATIONS

This application claims benefit, under 35 U.S.C. § 119(e), of U.S. provisional application Ser. No. 63/337,696, filed on May 3, 2022, and of U.S. provisional application Ser. No. 63/366,873, filed on Jun. 23, 2022.

### FIELD OF THE INVENTION

The present invention relates to coatings comprising a rare earth monosilicate and a rare earth disilicate, such as ytterbium monosilicate and ytterbium disilicate, and a method of manufacture thereof. More specifically, the present invention is concerned with such coatings for use as environmental barrier coatings.

### BACKGROUND OF THE INVENTION

The global increase in air travel requires commercial vehicles to be more efficient than ever before. Advanced engine hot section materials are a key technology required to keep fuel consumption and emission to a minimum in next-generation gas turbines. Ceramic matrix composites (CMCs) are the most promising material to revolutionize gas turbine hot section materials technology because of their excellent high-temperature properties. SiC/SiC ceramic matrix composites (CMCs) can fulfil the stringent requirements; however, they require protection from the operating environment and debris ingested during operation. Environmental barrier coatings (EBCs) enable the CMCs to operate under harsh conditions. EBC-coated CMCs will enable an increased efficiency and reduced pollutant and CO₂ emissions.

Multi-layer EBCs, deposited by different thermal spray techniques, have been widely investigated in the literature [1]. Currently, ytterbium monosilicate (Yb₂SiO₅) and disilicate (Yb₂Si₂O₇) are recognized as the most promising EBCs owing to their isomorphic nature, well-known thermo-mechanical properties, and high resistance against water vapour [2]. Despite the lower Yb₂SiO₅ volatility in water vapour, the closer thermal expansion coefficient (CTE) of the Yb₂Si₂O₇ (i.e. 4.1×10⁻⁶° C.⁻¹ [3]) to that of the SiC (i.e. 4.7×10⁻⁶° C.⁻¹ [2]) makes the latter a more promising candidate [3,4]. On the other hand, the higher CTE of Yb₂SiO₅ (7.5×10⁻⁶° C.⁻¹ [2]) promotes the thermal-stress-induced cracking in the coatings during thermal cycling. These cracks are considered preferential paths for the diffusion of oxygen and water vapour through the coating layers and affect the components' durability [4,5].

Due to the rapid solidification rates in thermal spray processes and the high amorphous phase formation tendency of silicates, deposition of highly crystalline ytterbium silicate coatings, particularly in as-sprayed form, is challenging. Amorphous deposits are not desirable because the CTE of amorphous Yb₂Si₂O₇ is higher than the crystalline structure (i.e. about twice as large), leading to a tensile stress generation in the coating and cracking during the cooling cycle [6]. Besides, the volume shrinkage associated with the crystallization of the amorphous phase at high temperatures during service (˜1000° C.) generates tensile stresses in the coating [7]. Almost entirely amorphous Yb₂Si₂O₇ coatings were formed by conventional atmospheric plasma spray (APS) with moderate plasma torch powers (25-60 Kw) [8,9]. It has been reported that keeping the substrate temperature above the glass-formation temperature of silicates (˜1000° C.) helps boost the crystallinity level of the coatings [7]. Crystalline Yb₂SiO₅ and Yb₂Si₂O₇ coatings were successfully deposited by placing the substrates in a furnace at 1200° C. during the spraying [2,10,11]. However, this does not seem a practical and cost-effective approach for industrial applications involving complex shapes and sizes. Another effective process to deposit crystalline Yb₂SiO₅ and Yb₂Si₂O₇ EBCs is achieved by the very low-pressure plasma spray (VLPPS) technique. High substrate temperatures stemming from the lack of thermal convection in the vacuum pressures of the VLPPS method (i.e., 0.5-10 Torr) results in highly crystalline deposits. Moreover, desirable microstructural properties such as high density and insignificant porosity and cracking are achieved by high particle temperatures and velocities in an expanded plasma jet of the VLPPS method [9,12]. Despite all the advantages of this technique, this process needs large vacuum chambers, and a complex and costly setup limits its practicability in industrial applications for large-scale manufacturing.

Another challenge of depositing ytterbium disilicate by thermal spray is achieving a desirable microstructure. The presence of any vertical cracks from top to bottom or any network of microcracks or discontinuities within the coating is not acceptable because they compromise the protecting characteristic of the EBC coatings against diffusion of oxidizing agents. Besides, the density and porosity levels of coating must be in an acceptable range. While high density and minimum porosity are desirable for environmental barrier purposes, uniform distribution of optimum porosity levels can improve the stress tolerance of the entire coating and prevent cracking in thermal-cyclic operations. Suspension plasma spray (SPS) has been applied to deposit Yb₂Si₂O₇ coatings, but the final microstructure was not desirable. Such coatings were 87% amorphous and suffered from segmentation cracks [3]. Bakan et al. [13] demonstrated that slightly improved crystallinity levels (˜35%) were obtained by high-velocity oxygen fuel (HVOF) spraying for Yb₂Si₂O₇ coatings. However, this increase, attributed to partially molten and non-molten particles associated with the lower flame temperature of HVOF, was reported to be detrimental for interfacial adhesion of the topcoat and increased porosity.

The volatilization of Si-bearing species with high vapour pressure from the molten droplets during the spraying process is another concern in depositing silicate EBCs. The preferential SiO₂ evaporation arising from the high power of thermal spray processes leads to deviation from stoichiometric coatings and, in the case of Yb₂Si₂O₇, Si-depleted secondary phases (i.e. Yb₂O₃ and Yb₂SiO₅) are formed in the final deposits [8,14]. The higher CTE of the Yb₂SiO₅ and Yb₂O₃ compared to that of the SiC substrates can deteriorate the thermal cyclic performance of the coatings. Owing to the high enthalpy of plasma in thermal spray, the formation of secondary phases in the final coatings is inevitable, but decreasing the concentration and size of Si-depleted phases and obtaining a uniform distribution through the entire coating thickness are critical.

Addressing the abovementioned deposition challenges of Yb₂Si₂O₇ EBCs by a more versatile, economical, and practical approach could be of significant interest.

### SUMMARY OF THE INVENTION

In accordance with the present invention, there is provided:
1. A coating comprising (preferably consisting of) a rare earth monosilicate and a rare earth disilicate, wherein the coating has a rare earth disilicate to rare earth monosilicate weight ratio of at least about 70:30, wherein the coating is at least 60% crystalline, wherein the coating comprises pores and has a porosity of at most about 40%, and wherein the coating is free of through-thickness cracks.
2. The coating of embodiment 1, wherein the rare earth monosilicate is of formula RE¹SiO₅, wherein RE¹ represents one or more rare earth elements.
3. The coating of embodiment 2, wherein RE¹ represents two or more rare earth elements.
4. The coating of embodiment 2, wherein RE¹ represents a single rare earth element.
5. The coating of any one of embodiments 1 to 4, wherein the rare earth element(s) in the rare earth monosilicate (i.e., RE¹) is(are) one or more of Y, Er, Gd, Yb, Lu, or Sc, and preferably is Yb.
6. The coating of any one of embodiments 1 to 5, wherein the rare earth disilicate is of formula RE²Si₂O₇, wherein RE² represents one or more rare earth element.
7. The coating of embodiment 6, wherein RE² represents two or more rare earth elements.
8. The coating of embodiment 6, wherein RE² represents a single rare earth element.
9. The coating of any one of embodiments 1 to 8, wherein the rare earth element in the rare earth disilicate (i.e., RE²) is(are) one or more of Y, Er, Gd, Yb, Lu, or Sc, and preferably is Yb.
10. The coating of any one of embodiments 1 to 9, comprising ytterbium monosilicate (Yb₂SiO₅) and ytterbium disilicate (Yb₂Si₂O₇).
11. The coating of any one of embodiments 1 to 10, being free of through-thickness cracks when observed by SEM.
12. The coating of embodiment any one of embodiments 1 to 11, wherein the rare earth disilicate to rare earth monosilicate weight ratio of the coating is at least about 75:25, preferably at least about 80:20, more preferably at least about 85:15, and most preferably at least about 90:10.
13. The coating of any one of embodiments 1 to 12, wherein the rare earth disilicate to rare earth monosilicate weight ratio of the coating is at most about 95:5, preferably at most about 90:10.
14. The coating of any one of embodiments 1 to 13, having a biphasic structure in which rare earth monosilicate phases are dispersed a rare earth disilicate matrix.
15. The coating of embodiment 14, wherein the rare earth monosilicate phases are uniformly dispersed throughout the matrix.
16. The coating of embodiment 14 or 15, wherein the rare earth monosilicate phases have an average diameter of at most about 10 μm, more preferably at a most about 5 μm.
17. The coating of any one of embodiments 1 to 16, being free of an oxide of a rare earth element, preferably being free of Yb₂O₃.
18. The coating of any one of embodiments 1 to 17, being at least 65% crystalline, preferably at least 75% crystalline, more preferably at least 80% crystalline, even more preferably at least 85% crystalline, even more preferably at least 90% crystalline, and most preferably being about 91% crystalline.
19. The coating of any one of embodiments 1 to 18, wherein the porosity is at most about 30%, preferably at most about 25%, more preferably at most about 20%, yet more preferably at most about 15%, and most preferably of about 10%,
20. The coating of any one of embodiments 1 to 19, wherein the porosity is at least about 2%, preferably at least about 5%, and most preferably about 10%,
21. The coating of any one of embodiments 1 to 20, wherein the pores have an average size of at most about 20 μm, preferably at most about 10 μm, and most preferably of about 5 μm.
22. The coating of any one of embodiments 1 to 21, being free of pores interconnected together and forming through-thickness channels or through-thickness cavities.
23. The coating of any one of embodiments 1 to 22, being free of pores interconnected together and forming channels or cavities that extends over about 90% or more, preferably about 80% or more, more preferably about 70% or more, yet more preferably about 60% or more, and most preferably about 50% or more of the thickness of the coating.
24. The coating of any one of embodiments 1 to 23, wherein the pores are uniformly dispersed in the coating.
25. The coating of any one of embodiments 1 to 24, being free of through-thickness networks of interconnected microcracks.
26. The coating of any one of embodiments 1 to 25, wherein the coating has microcracks,
27. The coating of any one of embodiments 1 to 26, wherein the microcracks have a cross-section that is at most about 5 μm, preferably at most about 2.5 μm, and most preferably about 1 μm in its largest dimension.
28. The coating of any one of embodiments 1 to 27, wherein inter-splat boundaries are invisible when observed by SEM at a magnification up to 2000×.
29. The coating of any one of embodiments 1 to 28, being substantially free of unmelted or partially melted starting material particles.
30. The coating of any one of embodiments 1 to 29, wherein microcracks in the coating heal when the coating is annealed at 1300° C. for 24 hours.
31. The coating of any one of embodiments 1 to 30, wherein no through-thickness cracks form in the coating when the coating is annealed at 1300° C. for 24 hours.
32. The coating of any one of embodiments 1 to 31, wherein the rare earth disilicate to rare earth monosilicate weight ratio increases by up to 2.5, preferably up to 5, more preferably up to 7.5, and most preferably up to 10 percentage points when the coating is annealed at 1300° C. for 24 hours.
33. The coating of any one of embodiments 1 to 32, having a thickness of about 50 μm to about 400 μm, preferably about 100 μm to about 300 μm, more preferably about 150 μm to about 300 μm, and most preferably about 200 μm to about 250 μm.
34. The coating of any one of embodiments 1 to 33 being an environmental barrier coating.
35. The coating of any one of embodiments 1 to 34 for use in coating a ceramic matrix composite, preferably a SiC ceramic matrix composite.
36. The coating of any one of embodiments 1 to 35 for use in a gas turbine.
37. Use of the coating of any one of embodiments 1 to 33 as an environmental barrier coating,
38. Use of the coating of any one of embodiments 1 to 33 for coating a ceramic matrix composite, preferably a SiC ceramic matrix composite.
39. Use of the coating of any one of embodiments 1 to 33 for use in a gas turbine.
40. A method for the manufacture of the coating of any one of embodiments 1 to 33, the method comprising:
   a) heating the substrate to at least about 500° C., and
   b) depositing the coating by atmospheric plasma spraying a coating precursor on the heated substrate,
   wherein the coating precursor is rare earth disilicate particles, and
   wherein the atmospheric plasma spraying is performed with a plasma spray torch operated at an operating power of at least 60 kW.
41. The method of embodiment 40, wherein during step a), the substrate is heated to at least about 600° C., preferably at least about 700° C., and most preferably at about 800° C.
42. The method of embodiment 40 or 41, wherein during step a), the substrate is heated using the plasma torch, preferably operated at an operating power of at least 50 kW, preferably at least about 70 kW, more preferably at least about 75 kW, yet more preferably at least about 80 kW, even more preferably at least about 85 kW, and most preferably about 90 kW.
43. The method of any one of embodiments 40 to 42, wherein during step a), the substrate is heated using the plasma torch, preferably operated at an operating power of at most about 120 kW, preferably at most about 110 kW, more preferably at most about 100 kW and most preferably at about 90 kW.
44. The method of any one of embodiments 40 to 43, wherein during step b), the torch is operated at an operating power of at least about 70 kW, preferably at least about 75 kW, more preferably at least about 80 kW, yet more preferably at least about 85 kW, and most preferably about 90 kW.
45. The method of any one of embodiments 40 to 44, wherein during step b), the torch is operated at an operating power of at most about 120 kW, preferably at most about 110 kW, more preferably at most about 100 kW and most preferably at about 90 kW.
46. The method of any one of embodiments 40 to 45, wherein the coating precursor is ytterbium disilicate particles.
47. The method of any one of embodiments 40 to 46, wherein the coating precursor in injected in the plasma axially at the root of the plasma and at the center of a cross-section of the plasma.
48. The method of any one of embodiments 40 to 47, wherein the atmospheric plasma spraying is performed at a stand-off distance of at most about 200 mm, preferably at most about 100 mm, and most preferably of 50 mm.
49. The method of any one of embodiments 40 to 48, wherein the atmospheric plasma spraying is performed at the shortest possible stand-off distance.
50. The method of any one of embodiments 40 to 49, wherein the atmospheric plasma spraying is performed at robot speed of about 200 mm/s to about 1500 mm/s, preferably about 500 mm/s to about 1000 mm/s, and most preferably 1000 mm/s.
51. The method of any one of embodiments 40 to 50, wherein the plasma torch is operated using as a plasma gas a mixture of any two of the following gases Ar, N₂, H₂ and He, preferably the mixture comprises N₂ and H₂ or Ar, N₂, and H₂, more preferably the mixture comprises:
   preferably from about 0% to about 80%, more preferably from about 10% to about 80%, yet more preferably from about 40% to about 50%, and most preferably about 45% of Ar,
   preferably from about 30% to about 80%, most preferably from about 40% to about 50%, and most preferably about 45% of N₂, and
   preferably from about 5% to about 40%, most preferably from about 10% to about 20%, and most preferably about 10% of H₂,
52. The method of any one of embodiments 40 to 51, wherein the atmospheric plasma spraying is performed at a plasma gas flow of about 100 L/minute to about 500 L/minute, preferably about 150 to about 300 L/minute, and most preferably about 200 L/minute.
53. The method of any one of embodiments 40 to 52, wherein the plasma torch is operated using N₂ or Ar, preferably Ar as a carrier gas.
54. The method of any one of embodiments 40 to 53, wherein the atmospheric plasma spraying is performed at carrier gas flow of about 5 L/minute to about 15 L/minute, preferably about 5 L/minute to about 10 L/minute, and most preferably about 8 L/minute.
55. The method of any one of embodiments 40 to 54, wherein the atmospheric plasma spraying is performed at a rare earth disilicate feed rate of about 2 g/minute to about 70 g/minute, preferably about 10 g/minute to about 30 g/minute, and most preferably about 15 g/minute to about 25 g/minute.
56. The method of any one of embodiments 40 to 54, wherein the atmospheric plasma spraying is performed with a nozzle have a diameter of about ¼ inch to about ½ inch, preferably about 5/16 inch to about ½ inch, and most preferably about ⅜ inch.
57. The method of any one of embodiments 40 to 56, wherein step b) is performed such that the average temperature of the rare earth disilicate particles is about 1800° C. to about 2500° C., preferably about 2000° C. to about 2400° C., and most preferably about 2300° C.
58. The method of any one of embodiments 40 to 57, wherein step b) is performed such that the average velocity of the rare earth disilicate particles is 200 m/s to about 600 m/s, preferably 300 m/s to about 500 m/s, and most preferably about 350 m/s to about 450 m/s.
59. The method of any one of embodiments 40 to 58, further comprising the step c) of slowly cooling the substrate after step b), preferably using the plasma spray torch.
60. The method of embodiment 59, wherein the substrate is cooled at a rate of at most about 200° C./minute, preferably at most about 130° C./minute, and most preferably about 80° C./minute.
61. The method of embodiment 59 or 60, wherein the substrate is cooled by gradually reducing the power of the plasma torch.
62. The method of embodiment 61, wherein the power of the plasma torch is reduced from the operating power to about 50 kW over a period of at least about 2 minutes, preferably at least about 3 minutes, and most preferably about 5 minutes.
63. The method of any one of embodiments 40 to 62, further comprising, after step b), and after step c) if step c) is present, annealing the coating.
64. The method of embodiment 63, wherein the coating is annealed at a temperature of at least about 1100° C., preferably at least about 1200° C., and most preferably of about 1300° C.
65. The method of embodiment 63 or 64, wherein the coating is annealed at a temperature of at most about 1480° C., preferably at most about 1400° C., and most preferably at most about 1300° C.
66. The method of any one of embodiments 63 to 65, wherein the coating is annealed for at least about 12 h, preferably at least about 24 h, and most preferably for about 48 h.

### BRIEF DESCRIPTION OF THE DRAWINGS

In the appended drawings:

FIG. 1 The substrate temperature profile during preheating, spraying and post-deposition torch heating, measured by the infrared camera for all the spraying conditions.

FIG. 2 The SEM back-scattered electron Images illustrate the microstructure of the Yb₂Si₂O₇ EBC coating deposited by high plasma torch power (90 kW).

FIG. 3 A higher magnification back-scattered electron image illustrates the Yb₂Si₂O₇ coating deposited with high power (90 kW).

FIG. 4 XRD pattern of as-sprayed Yb₂Si₂O₇ coatings deposited by high plasma torch power of 90 kW.

FIG. 5 The XRD quantitative phase analysis, crystallinity level, and deposition efficiency of the as-sprayed and annealed coatings deposited in different spraying conditions.

FIG. 6 The SEM back-scattered images illustrate the microstructure of the as-sprayed Yb₂Si₂O₇ coating without post-deposition torch heating. Cracking initiated from the surface of the coatings is indicated by the arrows.

FIG. 7 The SEM back-scattered electron images show the microstructure of the Yb₂Si₂O₇ coating by torch powers of (a) and (b) 72 kW as well as (c) and (d) 53 kW. Arrows indicate submicron unmelted fragments in figures (b) and (d).

FIG. 8 Different magnification SEM back-scattered images of the Yb₂Si₂O₇ coatings (90 kW) after annealing at 1300° C. for 24 hours. The secondary Yb₂SiO₅ phases are shown in figure (c). The grain boundaries and triple junctions demonstrating sintering of the coating are indicated in figure (d).

FIG. 9 Parameters and characteristics of the coatings produced in Example 2.

FIG. 10 SEM images of the coatings produced in Example 2.

FIG. 11 SEM images of the coatings produced in Example 2 at higher magnification.

FIG. 12 SEM images of the coatings produced in Example 2 at a robot speed of 50 cm/s at higher magnification (left image) and robot speed of 100 cm/s (right image)

FIG. 13 Parameters and characteristics of the coatings produced in Example 3.

FIG. 14 SEM images of the coatings produced in Example 3.

FIG. 15 SEM images of the coatings produced in Example 3 at higher magnification.

FIG. 16 Parameters and characteristics of the coatings produced in Example 4.

FIG. 17 SEM images of the coatings produced in Example 4

FIG. 18 SEM images of the coatings produced in Example 4 in higher magnification.

FIG. 19 shows the parameters used and the characteristics of the coatings produced in example 5.

FIG. 20 shows SEM images of the coatings produced in example 5.

FIG. 21 shows SEM images of the coatings produced in example 5 in higher magnification.

### DETAILED DESCRIPTION OF THE INVENTION

Turning now to the invention in more details, there is provided a coating comprising a rare earth monosilicate and a rare earth disilicate, preferably ytterbium monosilicate (Yb₂SiO₅) and ytterbium disilicate (Yb₂Si₂O₇), and a method for the manufacture of this coating.

There is also the use of this coating as an environmental barrier coating, preferably for a ceramic matrix composite, more preferably for a SiC ceramic matrix composite, yet more preferably for use in a gas turbine.

The coating of the invention is highly crystalline and can even reach exceptionally high crystallinity levels (up to ˜91%). An optimal fraction of disilicate (such as Yb₂SiO₅) secondary phases (preferably <20 wt. %) is evenly distributed in the coating. The uniform distribution of these small secondary phases (preferably <5 μm in size) through the coating thickness is beneficial to alleviate the stress generated due to CTE mismatch between the monosilicate and the disilicate. The porosity of the coating and the presence of cracks are also controlled. Isolated small porosities are uniformly distributed throughout the coating, which is desirable in EBC applications to improve the stress tolerance of the coatings.

The method of the invention is based on atmospheric plasma spray (APS) on a pre-heated substrate. If the substrate is not preheated, a rare earth disilicate such as Yb₂Si₂O₇ will typically not adhere on a SiC substrate, rather a Si bondcoat will be needed to allow adhesion. Such Si bondcoat works well but only up to a temperature of around 1400° C. that corresponds to its melting temperature. This is a severe limitation for future applications of EBCs. In the present invention, such limitation is avoided as the substrate is pre-heated, which surprisingly allows adhering Yb₂Si₂O₇ directly on a SiC substrate (i.e., without a Si bondcoat).

The method of the invention does not require any auxiliary heat-treatment during spraying, vacuum chamber, or subsequent furnace heat treatment, leading to considerable cost, time, and energy savings. The method achieves deposition efficiency of up to 85%. The method allows controlling the silicon mass evaporation during spraying limiting the formation of the disilicate (for example Yb₂Si₂O₇).

An optional gradual cooling by decreasing the torch power after spraying mitigates the thermal stress generated during the cooling cycle leading to fewer and/or thinner cracks and enhances the crystallinity level of the coatings by about 6%.

An optional annealing provides sintering and crack healing effect, while also transforming the monosilicate (such as Yb₂SiO₅) into the disilicate (such as Yb₂Si₂O₇) (up to ˜10 wt. %). Interestingly, this annealing could take place when the coating is in use, for example in a gas turbine, where it is exposed to high temperature.

### Coating

There is provided a coating comprising (preferably consisting of) a rare earth monosilicate and a rare earth disilicate, wherein the coating has a rare earth disilicate to rare earth monosilicate weight ratio of at least about 70:30, wherein the coating is at least 60% crystalline, wherein the coating comprises pores and has a porosity of at most about 40%, and wherein the coating is free of through-thickness cracks.

Herein, a “rare earth” element is an element of group 3 of the periodic table (atomic nos. 21, 39, 58, and 88) or of the lanthanide series (atomic nos. 58 to 71).

In preferred embodiments, the rare earth monosilicate is of formula RE¹SiO₅, wherein RE¹ represents one or more rare earth elements. In preferred embodiments, the rare earth element in the rare earth monosilicate (i.e., RE¹) is one or more of Y, Er, Gd, Yb, Lu, or Sc, more preferably it is Yb.

In embodiments, RE¹ represents two or more rare earth elements. In such embodiments, the rare earth monosilicate that can be arranged in one or more solid phases (in other words, the rare earth monosilicate is in a single solid-solution phase structure, in a dual solid-solution phase structure, or in a multi-solid-solution phase structure). Preferably, the rare earth monosilicate is arranged in a single solid-solution phase. In preferred alternative embodiments, RE¹ represents a single rare earth element.

In preferred embodiments, the rare earth disilicate is of formula RE²Si₂O₇, wherein RE² represents one or more rare earth element. In preferred embodiments, the rare earth element in the rare earth disilicate (i.e., RE²) is one or more of Y, Er, Gd, Yb, Lu, or Sc, more preferably it is Yb.

In embodiments, RE² represents two or more rare earth elements. In such embodiments, the rare earth disilicate that can be arranged in one or more solid phases (in other words, the rare earth disilicate is in a single solid-solution phase structure, in a dual solid-solution phase structure, or in a multi-solid-solution phase structure). Preferably, the rare earth disilicate is arranged in a single solid-solution phase. In preferred alternative embodiments, RE² represents a single rare earth element.

In preferred embodiments, the rare earth element(s) in the rare earth monosilicate (i.e., RE¹) is(are) the same as the rare earth element(s) in the rare earth disilicate (i.e., RE²). In alternative embodiments, the rare earth element(s) in the rare earth monosilicate (i.e., RE¹) and the rare earth element(s) in the rare earth disilicate (i.e., RE²) differ by at least one element.

In embodiments, the coating may comprise more than one rare earth monosilicate and/or more than one rare earth disilicate. In preferred embodiments, the coating comprises only one rare earth monosilicate and/or only one rare earth disilicate. In more preferred embodiments, the coating comprises only one rare earth monosilicate and only one rare earth disilicate.

In preferred embodiments, the coating comprises ytterbium monosilicate (Yb₂SiO₅) and ytterbium disilicate (Yb₂Si₂O₇).

In preferred embodiments, the coating is free of through-thickness cracks (also called mud cracks) when observed by SEM. Herein, through-thickness cracks are cracks that extend from the top to the bottom of the coating.

In preferred embodiments, the rare earth disilicate to rare earth monosilicate weight ratio of the coating is at least about 75:25, preferably at least about 80:20, more preferably at least about 85:15, and most preferably at least about 90:10.

In preferred embodiments, the rare earth disilicate to rare earth monosilicate weight ratio of the coating is at most about 95:5, preferably at most about 90:10.

In preferred embodiments, the coating has a biphasic structure in which rare earth monosilicate phases are dispersed a rare earth disilicate matrix. Preferably, the rare earth monosilicate phases are uniformly dispersed throughout the matrix. In preferred embodiments, the rare earth monosilicate phases have an average diameter of at most about 10 μm, more preferably at a most about 5 μm.

The coating may also comprise an oxide of a rare earth element, for example up to about 10 wt %, preferably up to about 5 wt % and more preferably up to about 2 wt % of such oxide, based on the total weight of the coating. This can happen when the rare earth monosilicate or rare earth disilicate is provided in admixture with such oxide or during spraying due to silicon evaporation. In preferred embodiments, the coating is free of an oxide of a rare earth element. In preferred embodiments, the coating is free of Yb₂O₃.

In preferred embodiments, the coating is at least 65% crystalline, preferably at least 75% crystalline, more preferably at least 80% crystalline, even more preferably at least 85% crystalline, even more preferably at least 90% crystalline, and most preferably about 91% crystalline.

In preferred embodiments, the porosity is at most about 30%, preferably at most about 25%, more preferably at most about 20%, and most preferably between about 10% and about 15%. In preferred embodiments, the porosity is at least about 5%, preferably at least about 8%, more preferably at least about 10%, and most preferably between about 10% and about 15%. All porosity levels herein were evaluated visually from SEM images.

In preferred embodiments, the pores in the coating have an average size of at most about 20 μm, preferably at most about 10 μm, and most preferably of about 5 μm.

In preferred embodiments, the coating is free of pores interconnected together and forming through-thickness channels or through-thickness cavities. Herein, through-thickness channels and through-thickness cavities are channels and cavities that extend from one side of the coating to the opposite side of the coating in the thickness direction. In more preferred embodiments, the coating is free of pores interconnected together and forming channels or cavities that extends over about 90% or more, preferably about 80% or more, more preferably about 70% or more, yet more preferably about 60% or more, and most preferably about 50% or more of the thickness of the coating.

In embodiments, the pores are uniformly dispersed in the coating. Herein, “uniformly distributed” means that the distribution the pores is constant throughout coating.

The pores in the coating may be of any shape.

In preferred embodiments, the coating is free of through-thickness networks of interconnected microcracks. Herein, such a network is a network that comprises a plurality of microcracks that connect with each other at a plurality of nodes and which extends from one side of the coating to the opposite side of the coating in the thickness direction.

For certainty, the coating can have microcracks, but they are not through-thickness microcracks, and they are not part of a through-thickness network. Herein, microcracks are cracks with a cross-section that is at most about 5 μm in its largest dimension. “Cracks” such as the above through-thickness cracks (mud cracks) are larger than microcracks and thus have a cross-section that is at least about 5 μm in its largest dimension. In preferred embodiments, the microcracks in the coating are at most about 2.5 μm, preferably about 1 μm in its largest dimension.

In preferred embodiments, the inter-splat boundaries in the coating are invisible when observed by SEM at a magnification up to 2000×. In other words, the coating exhibits complete inter-splat adhesion.

In preferred embodiments, microcracks in the coating heal when the coating is annealed at 1300° C. for 24 hours.

In preferred embodiments, no through-thickness cracks form in the coating when the coating is annealed at 1300° C. for 24 hours.

In preferred embodiments, the rare earth disilicate to rare earth monosilicate weight ratio increases when the coating is annealed at 1300° C. for 24 hours. Preferably the ratio increases by up to 2.5, more preferably 5, yet more preferably 7.5, and most preferably 10 percentage points. For certainty, an increase of 5 percentage points on a ratio of 85:15 (i.e., 85%) yields a ratio of 90:10 (i.e., 90%).

In embodiments, the coating of the invention has a thickness of about 50 μm to about 400 μm, preferably about 100 μm to about 300 μm, more preferably about 150 μm to about 300 μm, and most preferably about 200 μm to about 250 μm.

In embodiments, the coating of the invention is an environmental barrier coating. In preferred embodiments, the coating covers a ceramic matrix composite, preferably a SiC ceramic matrix composite.

### Methods

In a related aspect of the invention, there is also provide a method of manufacturing a coating as described above on a substrate. This method comprises
a) heating the substrate to at least about 500° C., and
b) depositing the coating by atmospheric plasma spraying a coating precursor on the heated substrate,
   wherein the coating precursor is rare earth disilicate particles, and
   wherein the atmospheric plasma spraying is performed with a plasma spray torch operated at an operating power of at least 60 kW.

In embodiments, the coating of the invention is an environmental barrier coating. In preferred embodiments, the substrate is a ceramic matrix composite, preferably a SiC ceramic matrix composite.

In preferred embodiments, the method is free of the step of surface roughening of the substrate. Indeed, excellent adhesion was observed without such a step.

In preferred embodiments, during step a), the substrate is heated to at least about 600° C., preferably at least about 700° C., and most preferably at about 800° C. As shown in Example 1, this maximizes the crystallization process. Preferably, the substrate is heated using the plasma torch (without coating precursor), preferably operated at the operating power of at least 50 kW, preferably at the preferred operating powers discussed below.

Thermal spraying techniques are coating processes in which a melted (or heated) coating precursor are sprayed onto a surface. The coating precursor is heated by electrical (plasma or arc) or chemical means (combustion flame). In plasma spraying, the coating precursor is heated by plasma. Atmospheric plasma spraying is plasma spraying carried under atmospheric pressure in ambient air. Other techniques include vacuum plasma spraying. Thermal spraying techniques are not interchangeable as they present different temperature and velocity profiles that have a significant impact of the coating produced.

In embodiments, during step b), the torch is operated at an operating power of at least about 70 kW, preferably at least about 75 kW, more preferably at least about 80 kW, yet more preferably at least about 85 kW, and most preferably about 90 kW. In preferred embodiments, the torch is operated at an operating power of at most about 120 kW, preferably at most about 110 kW, more preferably at most about 100 kW and most preferably at about 90 kW. As shown in Example 1, the plasma torch operated at 53 kW failed to produce an adequate coating. Also, the coating produced at 90 kW was of better quality than that produced at 72 kW. Decreasing the torch power diminishes silicon evaporation and Yb₂SiO₅ formation, increases the porosity of the coating produced by increasing the partially melted or unmelted fragments therein. Also, deposition efficiency increases with increasing power. The crystallinity level does not significantly change with torch powers in the above range.

In preferred embodiments, the torch is an Axial Ill plasma spray torch (by Mettech Northwestern Corp., Canada). This torch has three converging plasma jets (i.e., three separate cathode-anode pairs). Other torches that might be useful is the WSP-H 500 sold by ProjectSoft HK (Czech Republic) and the HE100 by Progressive surface (Michigan, USA).

The rare earth disilicate particles (coating precursor) are particles of a rare earth disilicate, preferably of formula RE²Si₂O₇, wherein RE² is as defined in the previous section.

In preferred embodiments, the coating precursor is ytterbium disilicate particles.

The rare earth disilicate particles used a coating precursor are advantageously a precursor powder sold for this purpose. In preferred embodiments, the ytterbium disilicate particles used a coating precursor are advantageously a precursor powder sold for this purpose, for example the “Ytterbium Disilicate Powder for Thermal Spray” sold by CElikon Metco®.

In preferred embodiments, the coating precursor in injected in the plasma axially at the root of the plasma and at the center of a cross-section of the plasma.

In embodiments, the atmospheric plasma spraying is performed at a stand-off distance of at most about 200 mm, preferably at most about 100 mm, and most preferably of 50 mm. In practice, it is typically best of use the shortest possible stand-off distance to ensure the highest substrate temperatures and reduce the particle dwell times so as to minimize Si evaporation. The “stand-off distance” is the distance between torch outer surface and the substrate.

In embodiments, the atmospheric plasma spraying is performed at robot speed of about 200 mm/s to about 1500 mm/s, preferably about 500 mm/s to about 1000 mm/s, and most preferably 1000 mm/s.

In preferred embodiments, the plasma torch is operated using as a plasma gas a mixture of any two of the following gases Ar, N₂, H₂ and He, preferably the mixture comprises N₂ and H₂ or Ar, N₂, and H₂. In preferred embodiments, the mixture comprises:
preferably from 0 to about 80%, more preferably from 10 to about 80%, yet more preferably from 40 to about 50%, and most preferably about 45% of Ar,
preferably from 30 to about 80%, most preferably from 40 to about 50%, and most preferably about 45% of N₂, and
preferably from 5 to about 40%, most preferably from 10 to about 20%, and most preferably about 10% of H₂,

In embodiments, the atmospheric plasma spraying is performed at a plasma gas flow of about 100 L/minute to about 500 L/minute, preferably about 150 to about 300 L/minute, and most preferably about 200 L/minute.

In preferred embodiments, the plasma torch is operated using N₂ or Ar, preferably Ar as a carrier gas.

In embodiments, the atmospheric plasma spraying is performed at carrier gas flow of about 5 L/minute to about 15 L/minute, preferably about 5 L/minute to about 10 L/minute, and most preferably about 8 L/minute.

In embodiments, the atmospheric plasma spraying is performed at a rare earth disilicate feed rate of about 2 g/minute to about 70 g/minute, preferably about 10 g/minute to about 30 g/minute, and most preferably about 15 g/minute to about 25 g/minute.

In embodiments, the atmospheric plasma spraying is performed with a nozzle have a diameter of about ¼ inch to about ½ inch, preferably about 5/16 inch to about ½ inch, and most preferably about ⅜ inch.

In embodiments, step b) is performed such that the average temperature of the rare earth disilicate particles is about 1800° C. to about 2500° C., preferably about 2000° C. to about 2400° C., and most preferably about 2300° C.

In embodiments, step b) is performed such that the average velocity of the rare earth disilicate particles is 100 m/s to about 600 m/s, preferably 300 m/s to about 500 m/s, and most preferably about 350 m/s to about 450 m/s.

In most preferred embodiments, the method further comprises the step c) of slowly cooling the substrate after step b), preferably using the plasma spray torch. Preferably, the substrate is cooled at a rate of at most about 200° C./minute, preferably at most about 130° C./minute, and most preferably about 80° C./minute. Preferably, the substrate is cooled by gradually reducing the power of the plasma torch. Preferably, the power of the plasma torch is reduced from the operating power to about 50 kW over a period of at least about 2 minutes, preferably at least about 3 minutes, and most preferably about 5 minutes. This step does not significantly change the rare earth disilicate to rare earth monosilicate weight ratio of the coating produced. Also, this step reduces thermal stress generated by cooling and increase the crystallinity of the coating produced. Thus, fewer cracks are formed.

As noted above, in preferred embodiments, all heat provided to the coating during steps a) to c) can be provided using the plasma torch. Therefore, it is an advantage of the invention that it does not require assistive heating.

It is an advantage of the invention that the method of the invention does not require any annealing or other type of post-deposition heat treatment to produce coatings with the excellent properties reported herein. However, annealing can have interesting effects on the coating produced. Indeed, annealing has a crack healing effect, closing most of the microcracks through the thickness coating. Annealing has a small effect on the crystallinity of the coating, but desirably transforms part of the Yb₂SiO₅ in the coating into Yb₂Si₂O₇. Therefore, in preferred embodiments, the method further comprises, after step b) (and after step c) if it is present), annealing the coating. Preferably, the coating is annealed at a temperature of at least about 1100° C., preferably at least about 1200° C., and most preferably of about 1300° C. In preferred embodiments, the coating is annealed at a temperature of at most about 1480° C., preferably at most about 1400° C., and most preferably at most about 1300° C. Preferably, the coating is annealed for at least about 12 h, preferably at least about 24 h, and most preferably for about 48 h. Preferably, the substrate is annealed in a furnace.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1—as-Sprayed Highly Crystalline Yb₂Si₂O₇ Environmental Barrier Coatings (EBCs) by Atmospheric Plasma Spray (APS)

### Summary

High amorphous phase formation tendency, a desirable microstructure and phase composition and silicon evaporation are the challenges of spraying Yb₂Si₂O₇ environmental barrier coatings (EBCs). This research aimed to investigate the feasibility of obtaining as-sprayed high-crystalline Yb₂Si₂O₇ coatings with desirable microstructure and composition by atmospheric plasma spray (APS) without any auxiliary heat-treating during spraying, vacuum chamber, or subsequent furnace heat treatment, leading to considerable cost, time, and energy savings. The established success, versatility, and robustness of the APS in the gas turbine industry can lead to a more practical and efficient method (i.e., energy and costs) to deposit such coatings.

Correspondingly, Yb₂Si₂O₇ powder was sprayed on SiC ceramic substrate using an axial injection plasma torch with modified spraying conditions. Then the microstructural evolution, phase composition and crystallinity level of the coatings were studied. To further analyze the microstructural stability of the coatings, annealing was carried out for 24 hours at a temperature close to the operating temperature of the coatings (1300° C.).

Yb₂Si₂O₇ powder was sprayed on SiC substrates with three different plasma powers of (90, 72 and 53 kW) and exceptional high crystallinity levels of up to ˜91% and deposition efficiency of up to 85% were achieved. The silicon mass evaporation during spraying was controlled with a short stand-ff distance of 50 mm, and an optimum fraction of Yb₂SiO₅ secondary phases (<20 wt. %) was evenly distributed in the final deposits.

The desirable microstructure, including a dense structure with uniform distribution of small porosities, was observed. The undesirable vertical crack formation and any interconnected discontinuities were prevented.

Reducing the plasma power from 90 kW to 53 kW, while conducive for mitigating the silicon mass loss, was detrimental for microstructure by increasing the fraction of porosities and partially melted or unmelted fragments.

The gradual decrease of the coating temperature after deposition alleviated microcracking but has an insignificant effect on the crystallinity level.

Coatings annealed close to their operating temperature at 1300° C. for 24 hours demonstrated a crack healing effect, closing the tiny microcracks through the thickness. An improved coating composition was detected after annealing by the transformation of Yb₂SiO₅ to Yb₂Si₂O₇ (up to ˜10 wt. %).

### Experimental

The coating feedstock powder used in this research was agglomerated and sintered Yb₂Si₂O₇ powder provided by Oerlikon Metco (Canada) Inc, with greater than 98% density. The thermal expansion coefficient (CTE) of the powder was reported by the supplier at the range of 4.5-5×10⁻⁶° C.⁻¹. The particle size distribution (D(10)=18 μm, D(50)=38.5 μm, and D(90)=69 m) was measured by laser diffraction and dynamic light scattering. The substrate specimens used in this study were Hexoloy® SA α-SiC discs (Saint-Gobain advanced ceramics LLC, USA) with 25.4 mm diameter and CTE of 4.2×10⁻⁶° C.⁻¹. The specimens were cleaned with acetone before thermal spraying to remove any contamination. The Yb₂Si₂O₇ feedstock was deposited on the SiC substrates in atmospheric pressure using a Mettech Axial Ill plasma spray torch (Mettech Northwestern Corp., Canada) with three converging plasma jets (i.e., three separate cathode-anode pairs) by axial injection of the powder directly at the center of the plasma.

Before spraying the particles, the substrates were preheated using the plasma torch with high power (90 kW) up to ˜750° C. to maximize the crystallization process. To control the cooling cycle and mitigate thermal-stress-induced-cracks and boost crystallization, the torch heating continued after spraying for up to five minutes, and the plasma power was reduced gradually. Three different torch powers (90, 72 and 53 kW) were employed by keeping the plasma gas composition constant but changing the plasma current to determine the best microstructure and phase composition. The stand-off distance was held at the shortest possible (50 mm) to ensure the highest substrate temperatures but reduce the particle dwell times to minimize the Si evaporation. The nozzle size of the torch was ⅜ inches. The plasma gasses used in this experiment were argon, nitrogen, and hydrogen. The process parameters used in this study are summarized in table 1. An infrared camera monitored the temperature of the substrates during the whole process. In addition, the average in-flight temperatures and velocities of the particles were diagnosed using a DPV evolution sensor (Tecnar Automation Lte, Canada), considering 2000 single particles. Finally, to assess the microstructure stability of the coatings, annealing was applied on the as-sprayed samples at 1300° C. for 24 hours using a tubular furnace at atmospheric pressure. The heating rate was 10° C./min, and the samples were cooled in the furnace afterward.

TABLE 1
The process parameters used to deposit Yb₂Si₂O₇ EBC coatings by atmospheric plasma spray (APS).

| | | | Stand- | | Plasma | | Carrier | | |
|---|---|---|---|---|---|---|---|---|---|
| | | | off | Robot | gas | | gas | Powder | Substrate |
| Plasma gas | Current | Power | distance | speed | flow | Carrier gas | flow | fed rate | temperature |
| composition | (A) | (kW) | (mm) | (mm/s) | (L/min) | composition | (L/min) | (gr/min) | (° C.) |
| Ar45%/N245%/ | 180 | 90 | 50 | 1000 | 200 | Ar | 8 | 20 | 700-750 |
| H210% | 140 | 72 | | | | | | | |
| | 100 | 53 | | | | | | | |

The coated samples were sectioned using a Secotom-15® precision cutter (Struers Ltd, Canada) with a diamond blade and then polished up to 1 μm using a Tegramin-25® automatic polishing machine (Struers Ltd, Canada). The preliminary microstructural investigations were conducted using an Olympus inverted optical microscope. Electron microscopic examinations and quantitative elemental analysis were carried out using a scanning electron microscope (SEM) in variable pressure mode, equipped with an energy dispersive spectroscopy (EDS), working at 15 kV. X-ray diffraction (XRD) analyses were conducted on the coated samples and the initial powder feedstock for phase detection by Bruker DRX D8 Advance. The XRD device was equipped with a Cu source (1.5418 Å) and a 40 kV and 40 mA working voltage and current, respectively. Spectra have been recorded from 10° to 70°, with an increment step of 0.02° and an integration time of 1 second. The quantitative phase analysis and crystallinity levels were measured using the reference intensity ratio (RIR) and the degree of crystallinity (DOC) methods.

### Results and Discussion

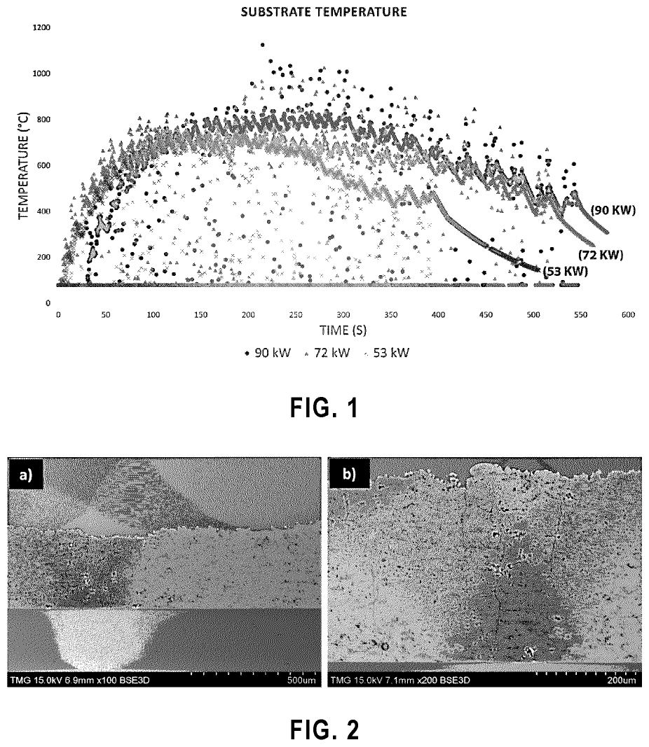

To encourage crystallization during spraying and improve the coatings' microstructure by preventing thermal stress-induced cracking, preheat and post-deposition torch heating were employed, and the substrate temperature was monitored through the entire duration of the process, as illustrated in FIG. 1.

The maximum preheat temperature of ˜750° C. was obtained for all the spraying conditions because the highest power (90 kW) was used to preheat the substrates. However, after the spraying started, substrates' temperature increased for the 90-kW condition due to the impact of particles with high temperatures. The average temperature and velocity of the particles for the 90-kW spraying condition were measured by DPV to be 2300° C. and 330 m/s, respectively. Nonetheless, for 72 kW and 53 kW spraying conditions, the substrate temperature decreased slightly during spraying since the spraying power was lower than the preheating power (90 kW). Furthermore, excellent control over the cooling cycle of the coatings is also demonstrated in these profiles by gradually decreasing the torch power after spraying was finished. The reason behind the short post-deposition treatment interval of the 53-kW sample was the quicker dropping of temperature by lower plasma torch power in this condition. This led to reaching lower temperatures faster than in the other conditions. The effect of this controlled preheat and post-deposition treatment on the improved crystallinity levels of the coatings and microstructure is further discussed below.

The microstructure of the as-sprayed Yb₂Si₂O₇, deposited using high torch power (90 kW), is illustrated in FIG. 2. Owing to the increased power of the plasma torch, the inter-splat boundaries are indiscernible in this microstructure, indicating an excellent inter-diffusion and adhesion between splats. In addition, no through-thickness vertical cracks (mud cracks) were observed in the coating, and a few microcracks within the coating were not forming networks and were isolated (FIG. 2b). Due to the plasma's high powers and enthalpy, the injected particles are predominantly melted, resulting in a dense coating with uniform distribution of tiny porosities across the coating. These porosities, if not interconnected, act as stress-tolerant regions in the coating and increase the overall durability and crack resistance of the EBC coatings. On the other hand, a significant fraction of porosities can compromise the environmental barrier function of the EBC coatings.

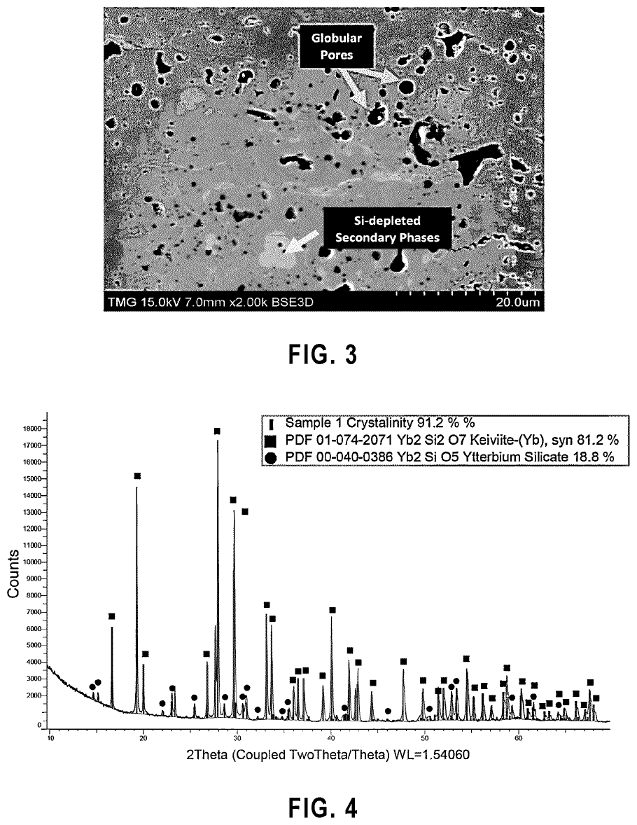

Other scholars have also reported the formation of porosities in the Yb₂Si₂O₇ coatings. For example, Bakan et al. [14] have stated that the pore formation was due to the solidification of the crystalline phase from the surface of the splats upon impact. The different densities of the molten amorphous phase (center of the splat) and the solidified crystalline phase (surface of the splat) result in stretching the molten phase and forming globular or various shaped pores inside the splats. The other motive behind porosities might be the lower gas solubility limit in the solidified crystalline phase than the molten amorphous phase. Such pores with different morphologies are indicated in FIG. 3.

The secondary phase with a brighter contrast is also demonstrated in this figure. The SEM-EDS compositional analysis of this phase and the darker matrix, reported in table 2, suggests silicon depletion in the brighter phases.

TABLE 2

| Elements | O | Si | Yb |
|---|---|---|---|
| Bright secondary | 31.98 | 25.80 | 42.22 |
| phase | | | |
| Gray matrix | 30.15 | 38.61 | 31.25 |

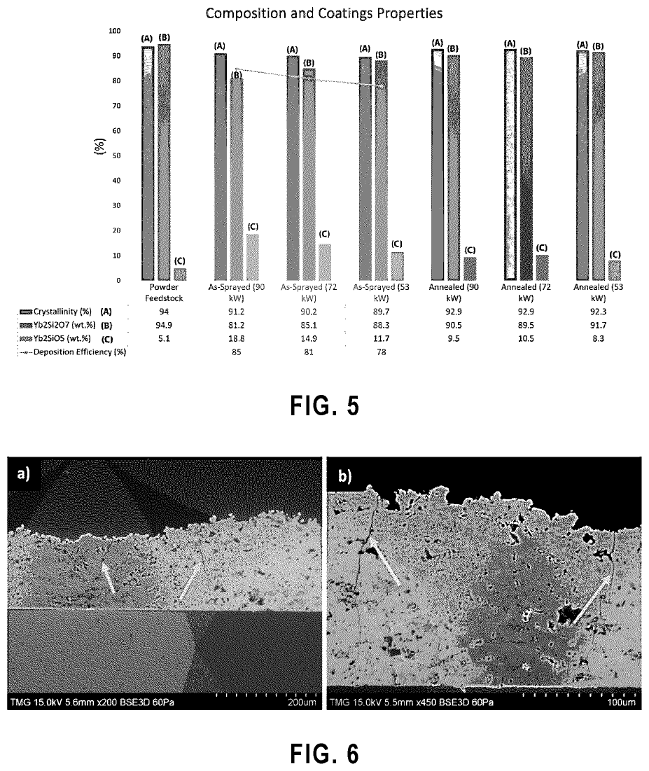

For phase characterization and measuring the phase content in the final coatings, XRD analysis was carried out. FIG. 4 shows the XRD pattern of the as-sprayed Yb₂Si₂O₇ coating, deposited with high power (90 kW). Yb₂Si₂O₇ and Yb₂SiO₅ were detected in the coating after indexing the XRD spectrum. The XRD quantitative phase analysis (QPA) results and crystallinity level of the initial feedstock and all the as-sprayed and annealed coatings are reported in FIG. 5.

Since the initial powder was composed of only 5 wt. % Yb₂SiO₅ (see FIG. 5), the higher amount of this phase in the final coatings revealed the silicon mass loss during spraying. The formation of such phases was attributed to the evaporation of silicon-bearing species with high vapour pressure inside high temperatures of the plasma plume. This results in the formation of Si-depleted secondary phases in the final coating. The SEM-EDS elemental analysis (table 2) accompanied by QPA results (FIG. 5) revealed that the brighter phase, illustrated in FIG. 3, is the Yb₂SiO₅. Based on the Yb₂O₃—SiO₂ binary phase diagram [3], solidification of Yb₂O₃ is also possible in case of severe silicon evaporation during spraying. However, this approach lacks Yb₂O₃ formation, and minor concentrations of Yb₂SiO₅ secondary phases (<20 wt. %) in the as-sprayed Yb₂Si₂O₇ coatings demonstrate minimal silicon evaporation during spraying. Besides, the uniform distribution of the small Yb₂SiO₅ particles (<5 m) through the coating thickness could potentially alleviate the adverse effect of the CTE mismatch between Yb₂Si₂O₇ and Yb₂SiO₅ in actual cyclic engine conditions.

Based on the XRD spectra, high crystallinity levels of ˜90% were measured by the DOC method for all the conditions (see FIG. 5), which is a breakthrough for an as-sprayed Yb₂Si₂O₇ EBC coating. Achieving almost similar high crystallinity levels regardless of the deposition power revealed that the crystallization was most likely independent of the particle temperatures during spraying but mainly relied on the substrate temperature after the preheating cycle and possibly post-deposition torch heating. It is of note that preheating cycle before onset of spraying and the post-deposition torch heating were the same for all the spraying conditions.

Nevertheless, the highest substrate temperature obtained in this study was ˜750° C., and still far from the Yb₂Si₂O₇ crystallization temperature (˜1000° C.). On the contrary to other studies that encouraged reaching 1200° C. during spraying to improve crystallinity [2,10], in this invention, high levels of crystallinity were attained in lower substrate temperatures. Since crystallization is a diffusion-based phenomenon, it depends on both the time and the temperature. Therefore gradual cooling of the molten droplet between high temperatures of spraying (˜2300° C.) and the crystallization temperature (˜1000° C.) can lead to nucleation of crystallites. It seems that by reaching the substrate temperature of ˜750° C., favourable nucleation kinetics was obtained, providing enough time above the crystallization temperature (1000° C.) to boost crystalline nucleation.

The measured substrate temperature is always below the actual maximum temperature at the camera's focus using the infrared camera. The maximum temperature is achieved when the camera lens is covered by the torch moving over the camera's mark on the substrate. Thus, there always is a lag between the temperature measurement and the heating of the substrate. Therefore, it can be deduced that the actual substrate temperatures were even higher than the measured values, which better explains the high levels of crystallization in this experiment. Moreover, the coating was annealed in real-time with high torch powers and high enthalpy plasma [15]. The high enthalpy of the N₂ and high thermal conductivity of H₂ gases most likely create the condition to keep the coating temperature above the crystallization temperature long enough to enhance the crystallization process. In other words, the successive deposition of splats and the very close movement (i.e. 50 mm stand-off distance) of the high enthalpy plasma plume over the deposited splats in each pass moderates the cooling rate of splats and promotes crystal formation.

To investigate the effect of post-deposition torch heating on the crystallization level of the coatings, one sample was deposited in the same condition (90 kW) but without post-deposition treatment (FIG. 6). The XRD analysis revealed a slight decrease in crystallinity level (˜6%), but the phase composition was almost like the post-deposition treated coatings. Therefore, it could be understood that the post-deposition torch heating had a minor effect on the crystallization of the Yb₂Si₂O₇ coating, and the crystallinity is primarily dependent on the preheating temperature and torch power. Nonetheless, post-deposition torch heating could benefit microstructure and alleviate microcracking by controlling the thermal stress generated within the coatings during the cooling cycle.

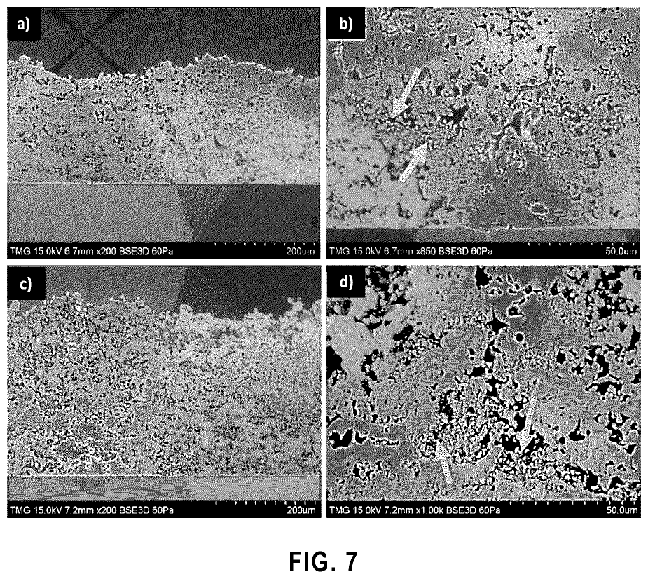

FIG. 7 shows the microstructure of the Yb₂Si₂O₇ coatings, deposited using two lower torch powers (i.e. 72 kW and 53 kW) for comparative studies. The microstructure of the Yb₂Si₂O₇ coatings, deposited by lower powers, is principally similar to the coatings with higher power (90 kW) free from large vertical cracks but several tiny microcracks. However, the most notable change in the microstructure of the EBC coatings by decreasing the torch power is the increment of the porosities. The increase in the level of porosities which is more severe in the coldest condition (53 kW), could be stem from the lower enthalpy of the plasma with lower powers. In such conditions, colder particle temperatures led to the deposition of partially melted or unmelted particles trapped between splats and increased the porosity levels of the final coating. In addition, the initial powders were agglomerated and sintered spheres which were composed of submicron particles. Thus, a drop in the thermal conductivity of the powder from the surface into the interior part of the sphere is predictable. In a colder plasma condition (e.g. 72 kW and 53 kW), there is a high probability that some portion of the single particles (i.e. most likely the interior parts) were not melted and broken up after impact with the substrate leaving a series of tiny submicron size fragments. Such fragments are demonstrated in colder conditions in FIGS. 7b and 7d. Therefore, lower deposition rates are expected by raising the unmelted portion of the particles. This complies with the decline in deposition efficiency from 85% to 78% by decreasing the torch power from 90 kW to 53 kW (FIG. 5).

The XRD phase composition of the coatings deposited by 72 kW and 53 kW shows a reduction in the concentration of the Yb₂SiO₅ secondary phase (FIG. 5). This implies lower levels of silicon mass loss during spraying, stemming from the colder spraying conditions in lower torch powers. While lower powers appeared superior in phase composition, the more porous microstructure and higher volume of partially melted or unmelted fragments throughout the deposits could deteriorate the environmental barrier function of EBCs. Accordingly, it can be deduced that despite a slightly higher concentration of Yb₂SiO₅ in the high-power sample (90 kW), this coating was significantly superior in terms of the microstructure desirable for EBC applications (see FIG. 2). Therefore, the most acceptable spraying condition with optimum phase composition and microstructure was the as-sprayed Yb₂Si₂O₇ coating deposited using the high torch power of 90 kW.

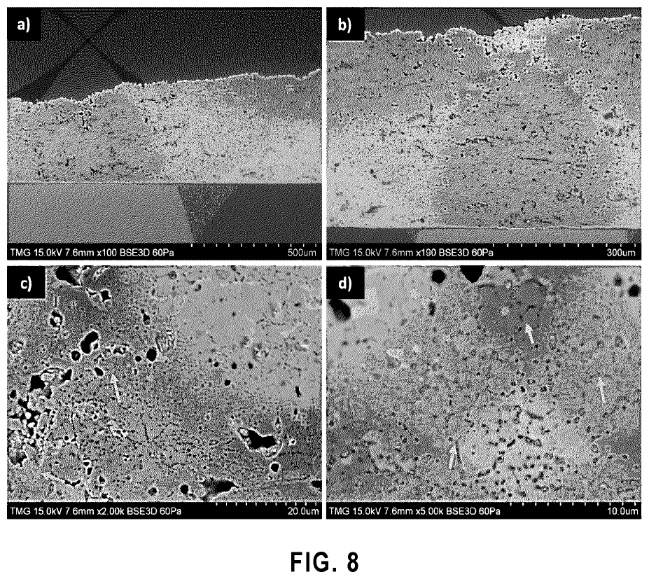

FIG. 8 illustrates the microstructure of the Yb₂Si₂O₇ coating, deposited by 90 kW torch power after annealing for 24 hours at 1300° C. It is of note that by the employment of the current approach to deposit Yb₂Si₂O₇ EBC coatings, no annealing or any type of post-deposition heat treatment is required. The only reason the samples were annealed in this study was to assess the microstructural stability and performance of the coatings in a temperature close to the coatings operating temperature. After annealing, the coatings' microstructure was dense with uniform distribution of small porosities and Yb₂SiO₅ secondary phases. The lack of vertical cracks formation after annealing was also noticed, implying that the tensile stress generated in the coating during the annealing process was not enough to form any type of cracks. Since the as-sprayed coatings were already highly crystalline (˜90% in all the conditions), and a negligible crystallization (<3%) occurred during annealing (see FIG. 5), the shrinkage associated with crystallization of the amorphous phase was avoided during the annealing, further explaining the lack of cracking. This is of great importance because vertical cracks and mud cracks could act as preferential paths for the diffusion of oxidizers and compromise the environmental barrier function of the coatings.

Another significant finding is the healing of the microcracks, already presented in the as-sprayed coatings (see FIG. 2). Garcia et al. [21] also reported such crack healing in their work on heat treatment of amorphous Yb₂Si₂O₇ coatings. They have stated that the crack healing after the heat treatment of as-sprayed coatings was attributed to the expansion associated with the transformation of a metastable P21/c Yb₂SiO₅ to stable I2/a Yb₂SiO₅ after annealing at 1300° C. However, such a metastable phase was not detected in any coatings in this study; thus, the crack healing effect might be attributed to a different cause. Higher magnification images from the annealed microstructure (FIGS. 8c and 8d) demonstrate the sintering signs in such coatings. This suggests that in the high annealing temperature of 1300° C. and prolonged holding time of 24 hours, the diffusion condition required for the fine particles' sintering and densification was met. Moreover, the expansion associated with the heating of the coatings up to 1300° C. and the fact that the coating is constraint by the substrate were conducive to the closing of the microcracks.

While both the Yb₂Si₂O₇ and Yb₂SiO₅ phases were also detected in the annealed samples, the phase contents were changed. A transformation of Yb₂SiO₅ to Yb₂Si₂O₇ was observed after annealing. The decrease of Yb₂SiO₅ content from ˜19 wt. % in the as-sprayed deposit to ˜10 wt. % after annealing (see FIG. 5) is desirable since the higher CTE of the Yb₂SiO₅ could adversely affect the thermal-cyclic durability of the coatings. The same phase transformation has been reported by Jang et al. [16] in their study on isothermal heat treatment of Yb₂SiO₅ EBCs. The reason behind such a transformation arises from the following reaction:

Yb₂SiO₅(S)+SiO₂(S)→Yb₂Si₂O₇(s) (1)

While no excess SiO₂ was detected in the initial powder or any of the final deposits, the phase content might be below the XRD or EDS detection limit. Moreover, the exposure of the SiC substrate for 24 hours at 1300° C. results in slight oxidation of the SiC substrates and the formation of a very thin silica layer that can react with Yb₂SiO₅ to form Yb₂Si₂O₇. SiC oxidation and silica formation have been reported during only 4 hours of annealing at the same temperature of 1300° C. for the same coating system deposited by APS [17].

### CONCLUSION

As-sprayed highly crystalline Yb₂Si₂O₇ coatings were successfully deposited using plasma spray at atmosphere (APS) with three different torch powers of 90, 72 and 53 kW without needing any assistive heating, furnace, or vacuum chamber. The principal findings of this study could be summarized as follows:
High crystallinity levels of up to ˜91% were achieved for all the as-sprayed conditions regardless of the torch power. The microstructure of the coatings was dense, and complete inter-splat adhesion was observed in all the spraying conditions. Coatings were free from vertical cracks and interconnected pores or discontinuities. Nevertheless, isolated small porosities were uniformly distributed throughout the deposits, which is desirable in EBC applications to improve the stress tolerance of the coatings.
Silicon evaporation during spraying was detected, resulting in the formation of Yb₂SiO₅ secondary phases in the final deposits. However, minor phase contents of Yb₂SiO₅ (<20 wt. %) in all torch powers and lack of Yb₂O₃ formation implied that the silicon mass loss was mitigated in this study. Moreover, the uniform distribution of these small secondary particles (<5 μm in size) through the coating thickness is beneficial to alleviate the stress generated due to CTE mismatch between Yb₂Si₂O₇ and Yb₂SiO₅.
While decreasing the torch power from 90 kW to 53 kW diminished the silicon evaporation and Yb₂SiO₅ formation (˜7 wt. %), the porosity level of the coatings raised by increasing the partially melted or unmelted fragments in lower plasma enthalpy of lower torch powers. This resulted in a drop in the deposition efficiency from 85% for 90 kW to 78% for 53 kW spraying conditions. The crystallinity level of the coatings was insensitive to any change of the plasma enthalpy during spraying, indicating that substrate temperature during preheating and the cooling rate between passes dominated crystallization.
It was demonstrated that post-deposition torch heating by gradually decreasing the torch power after spraying could mitigate the thermal stress generated during the cooling cycle and enhance the crystallinity level of the coatings by about 6%. Thicker cracks were initiated from the surface of the EBC in lack of such treatment, but cracking was less severe with post-deposition treatment. The post-deposition treatment was almost ineffective on the phase composition of the coatings.

Annealing the as-sprayed Yb₂Si₂O₇ EBCs at 1300° C. for 24 hours revealed a crack healing effect, and most of the microcracks through the thickness of the EBC were closed. While the microstructure of the annealed samples remained dense, specific sintering indications could be observed. The annealing process had a negligible effect on the crystallinity level improvement (<3%), but a desirable transformation of Yb₂SiO₅ to Yb₂Si₂O₇ (up to 9 wt. %) was demonstrated due to the reaction of Yb₂SiO₅ with Si₂O.

### Example 2—Varying Robot Speed

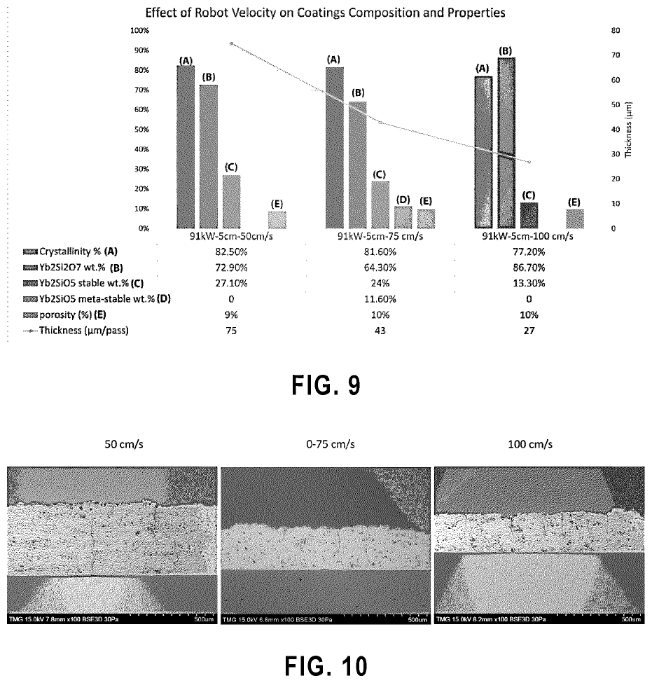

Coatings were produced as described in Example 1, except that the robot speed was varied. The coating produced at 50 cm/s demonstrated the highest crystallinity level with ˜82% and by increasing the robot velocity to 100 cm/s the crystallinity dropped for ˜5%. This is because in slower robot velocities, the total time that the torch is on the substrate increased resulting in transferring more heat from the plasma to the sample. The lower crystallinity level of the coating with 100 cm/s in this example in comparison to the same condition in example 1 might be due to lower substrate temperature obtained prior to spraying in the current experiment (˜600° C. in comparison to ˜750° C. in example 1). The slower movement of the torch on the sample during spraying also resulted in higher deposition rates (μm/pass) as illustrated in FIG. 9. The thickness of the coating per pass dropped from 75 μm for 50 cm/s sample to 27 μm for 100 cm/s sample. Moreover, due to higher temperature of the substrate in lower speed conditions the evaporation of silicon and formation of Yb₂SiO₅ were more severe. High magnification SEM images revealed that while in 50 cm/s condition, the concentration of the Yb₂SiO₅ is higher than the 100 cm/s (27 wt. % vs ˜13 wt. %), the morphology of these particles is finer and more delicate in the former. The image analysis of the SEM microstructures demonstrated that the porosity levels in all the conditions were almost the same and the changes were negligible.

FIG. 9 shows the parameters used and the characteristics of the coatings obtained.

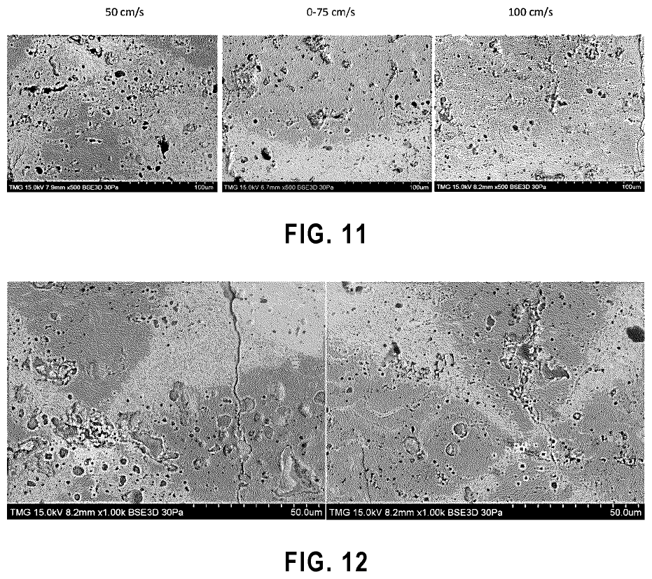

FIGS. 10 to 12 show SEM images of the coatings produced at different magnifications.

### Example 3—Varying the Feed Rate

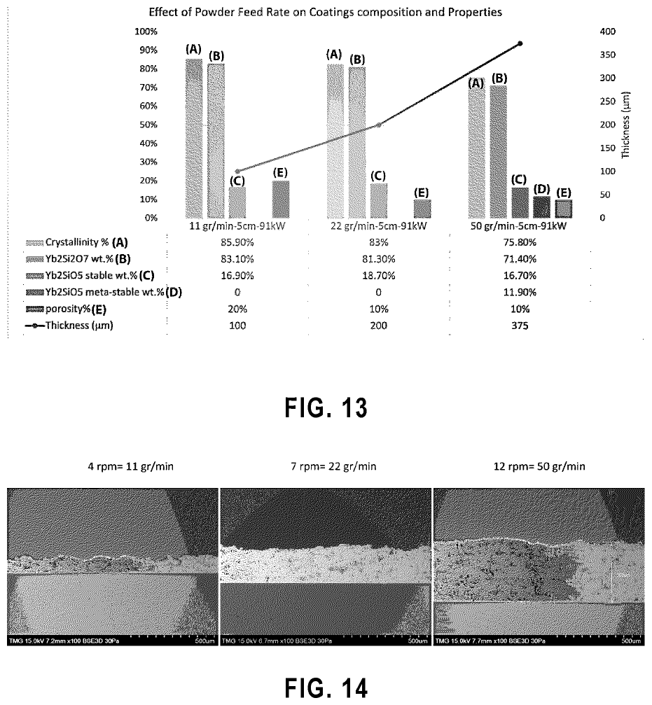

Coatings were produced as described in Example 1, except that the feed rate of the Yb₂SiO₅ was varied. As can be seen in FIG. 13, the crystallinity levels of the coating with lower feed rate of 4 gr/min is higher than the 50 gr/min sample. Since the amount of powder injected through the plasma in the slower federate is lower, less thermal energy of the plasma is absorbed by the particles and more heat is transferred into the substrate resulting in higher temperatures during spraying and subsequently an improved crystallinity level. The higher concentration of the Yb₂SiO₅ phase in 50 gr/min samples compared with 11 gr/min may arise from inconsistent feeding of the powder feeder in very high rates. The image analysis revealed that the low feed rate of 11 gr/min result in a very porous microstructure (˜20%) with lower deposition rate (˜12 μm/pass) in comparison to the highest feeding rate (10% porosity and 46 μm/pass). The porosity level difference between the 50 gr/min sample and 22 gr/min sample were almost the same.

FIG. 13 shows the parameters used and the characteristics of the coatings obtained.

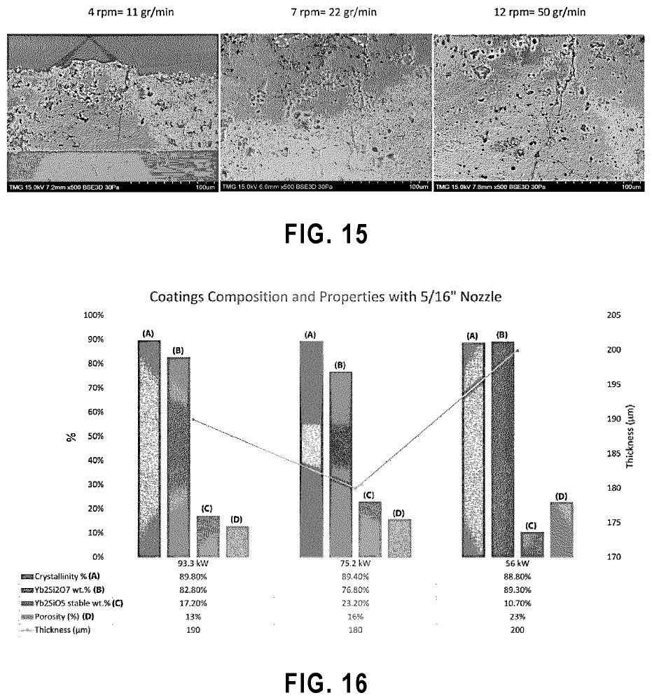

FIGS. 14 and 15 show SEM images of the coatings produced.

### Example 4—Varying the Nozzle Size

Coatings were produced as described in Example 1, except that the nozzle size was reduced to 5/16″.

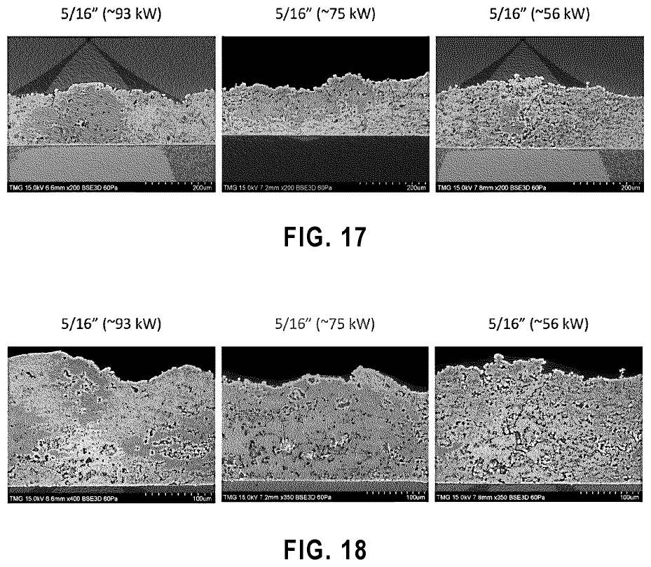

By reducing the nozzle diameter from ⅜″ to 5/16″, higher torch powers were obtained in the same electric currents compared to the example 1. Besides, in-flight particle analysis demonstrated that the particle velocities increased in all the torch powers by the 5/16″ nozzle size verses the ⅜″ (e.g., in the highest torch power elevated from ˜400 m/s to 500 m/s), resulting in less porosity levels and denser coatings. Denser coatings lead to lack of stress tolerance and more cracking was observed in comparison to example 1 microstructures, as illustrated in FIG. 17. Similar to Example 1, the porosity level of the coating increased by reducing the torch power from ˜93 kW to 56 kW. The reason behind the more porous microstructure of the coatings in lower powers was the lower temperature of the plasma in 75 and 56 kW, leading to more interruption of un-melted or partially melted particles within the final deposit. The slightly higher thickness of the coating (˜20 μm) despite lower deposition efficiency in 56 kW verses the 93 kW is due to the porous microstructure of the coating by the lower torch power. The negligible torch power difference between 5/16″ nozzle diameter and ⅜″ in Example 1 had no significant effect on the composition of the coatings and the ratio of Yb₂SiO₅ to Yb₂Si₂O₇ was almost the same for the same conditions in both the examples.

FIG. 16 shows the parameters used and the characteristics of the coatings obtained.

FIGS. 17 and 18 shows SEM images of the coatings produced with a 5/16″ Nozzle at a stand-off distance of 5 cm and a feed rate of 20 gr/min.

### Example 5—Varying the Stand-Off Distance

Coatings were produced as described in Example 1, except that the stand-off distances varied.

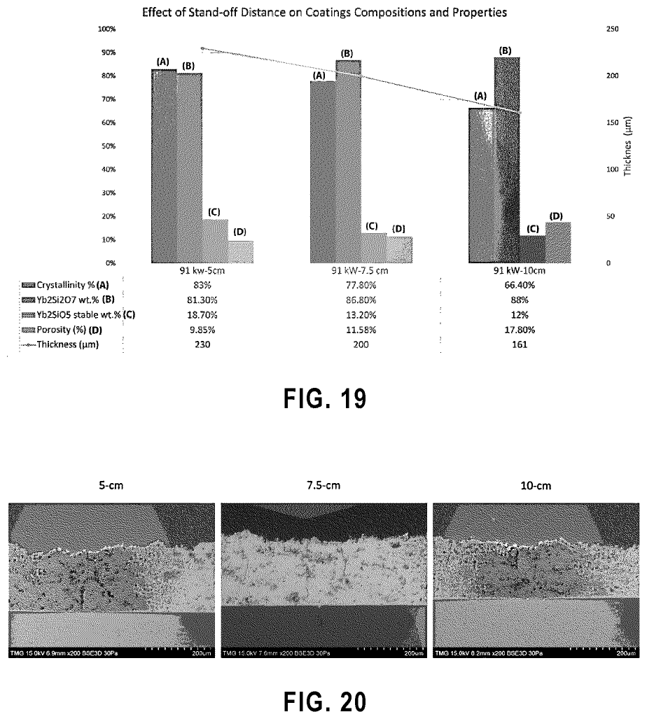

As can be seen in FIG. 19, since less thermal energy was received by the substrate from the plasma in longer stand-off distances, the crystallinity level of the coatings decreased from 83% to 66% by raising the stand-ff distance from 5 cm to 10 cm. This clearly shows that to obtain higher crystallinity levels, shorter stand-off distances are preferred. Furthermore, as reported in FIG. 19, coatings became more porous by increasing the stand-off distance which is most likely due to the larger portion of cooled-down, un-melted and/or partially melted particles in such conditions. Higher Yb₂Si₂O₇ content in 10 cm stand-off distance can also be attributed to the higher content of fully crystalline partially melted or un-melted powder particles which were deposited as they were initially injected. However, further investigations are required to better understand the composition of the coatings.

FIG. 19 shows the parameters used and the characteristics of the coatings obtained.

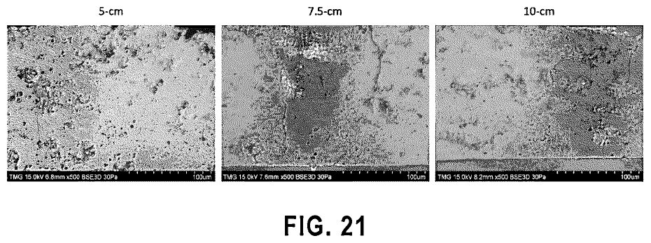

FIGS. 20 and 21 show SEM images of the coatings produced by different stand-off distances.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
1. Y. Xu, X. Hu, F. Xu, K. Li, Rare earth silicate environmental barrier coatings: present status and prospective, Ceramics International, 43(8), 5847-5855 (2017)
2. B. T. Richards, H. Zhao, H. N. Wadley, Structure, composition, and defect control during plasma spray deposition of ytterbium silicate coatings, Journal of materials science, 50(24), 7939-7957 (2015)
3. E. Bakan, D. Marcano, D. Zhou, Y. J. Sohn, G. Mauer, R. Vaßen, Yb 2 Si 2 O 7 Environmental Barrier Coatings Deposited by Various Thermal Spray Techniques: A Preliminary Comparative Study, Journal of Thermal Spray Technology, 26(6), 1011-1024 (2017)
4. K. N. Lee, Environmental barrier coatings for SiCf/SiC, Ceramic matrix composites: materials, modeling and technology, 430-451 (2014)
5. B. T. Richards, M. R. Begley, H. N. Wadley, Mechanisms of ytterbium monosilicate/mullite/silicon coating failure during thermal cycling in water vapor, Journal of the American Ceramic Society, 98(12), 4066-4075 (2015)
6. E. Garcia, H. Lee, S. Sampath, Phase and microstructure evolution in plasma sprayed Yb2Si2O7 coatings, Journal of the European Ceramic Society, 39(4), 1477-1486 (2019)
7. R. Lima, D. Zhu, L. Li, Thermal and Environmental Barrier Coatings (TBCs/EBCs) for Turbine Engines, ASM Handbook, 5, 270-279 (2013)
8. T. Zhu, Y. Niu, X. Zhong, J. Zhao, Y. Zeng, X. Zheng, C. Ding, Influence of phase composition on microstructure and thermal properties of ytterbium silicate coatings deposited by atmospheric plasma spray, Journal of the European Ceramic Society, 38(11), 3974-3985 (2018)
9. R. VaBen, E. Bakan, C. Gatzen, S. Kim, D. E. Mack, O. Guillon, Environmental Barrier Coatings Made by Different Thermal Spray Technologies, Coatings, 9(12), 784 (2019)
10. B. T. Richards, H. N. Wadley, Plasma spray deposition of tri-layer environmental barrier coatings, Journal of the European Ceramic Society, 34(12), 3069-3083 (2014)
11. B. T. Richards, K. A. Young, F. de Francqueville, S. Sehr, M. R. Begley, H. N. Wadley, Response of ytterbium disilicate-silicon environmental barrier coatings to thermal cycling in water vapor, Acta Materialia, 106, 1-14 (2016)
12. X. Zhang, J. Song, Z. Deng, C. Wang, S. Niu, G. Liu, C. Deng, C. Deng, M. Liu, K. Zhou, Interface evolution of Si/Mullite/Yb2SiO5 PS-PVD environmental barrier coatings under high temperature, Journal of the European Ceramic Society, 40(4), 1478-1487 (2020)
13. E. Bakan, G. Mauer, Y. J. Sohn, D. Koch, R. VaBen, Application of high-velocity oxygen-fuel (HVOF) spraying to the fabrication of Yb-silicate environmental barrier coatings, Coatings, 7(4), 55 (2017)
14. E. Bakan, Y. J. Sohn, W. Kunz, H. Klemm, R. VaBen, Effect of processing on high-velocity water vapor recession behavior of Yb-silicate environmental barrier coatings, Journal of the European Ceramic Society, 39(4), 1507-1513 (2019)
15. R. S. Lima, C. V. Cojocaru, C. Moreau, Y. Wang, Method and Apparatus for Depositing Stable Crystalline Phase Coatings of High Temperature Ceramics, ed., Google Patents, 2014
16. B.-K. Jang, N. Nagashima, S. Kim, Y.-S. Oh, S.-M. Lee, H.-T. Kim, Mechanical properties and microstructure of Yb2SiO5 environmental barrier coatings under isothermal heat treatment, Journal of the European Ceramic Society, 40(7), 2667-2673 (2020)
17. K. A. Kane, E. Garcia, S. Uwanyuze, M. Lance, K. A. Unocic, S. Sampath, B. A. Pint, Steam oxidation of ytterbium disilicate environmental barrier coatings with and without a silicon bond coat, Journal of the American Ceramic Society, 104(5), 2285-2300 (2021)
WO 2013/075202 A1
CN 106244977 A
CN 112063962 A
CN 109023201 A
CN 113278909 A
CN 113249676 A
CN 108911791 A
E. Garcia, O. Sotelo-Mazon, C. A. Poblano-Salas, G. Trapaga, S. Sampath, Characterization of Yb₂Si₂O₇—Yb₂SiO₅ composite environmental barrier coatings resultant from in situ plasma spray processing, Ceramics International, Volume 46, Issue 13, September 2020, Pages 21328-21335.
Markus Wolf, Daniel Emil Mack, Georg Mauer, Olivier Guillon, Robert VaBen, Crystalline ytterbium disilicate environmental barrier coatings made by high velocity oxygen fuel spraying, International Journal of Applied Ceramic Technology, Volume 19, Issue 1, January/February 2022, Pages 210-220
Dong et al., High-entropy environmental barrier coating for the ceramic matrix composites, Journal of the European Ceramic Society 39 (2019) 2574-2579.

1. A coating comprising a rare earth monosilicate and a rare earth disilicate, wherein the coating has a rare earth disilicate to rare earth monosilicate weight ratio of at least about 70:30, wherein the coating is at least 60% crystalline, wherein the coating comprises pores and has a porosity of at most about 40%, and wherein the coating is free of through-thickness cracks.

2. The coating of claim 1, wherein the rare earth monosilicate is of formula RE¹SiO₅, wherein RE¹ represents one or more rare earth elements.

3.-5. (canceled)

6. The coating of a claim 1, wherein the rare earth disilicate is of formula RE²Si₂O₇, wherein RE² represents one or more rare earth element.

7.-9. (canceled)

10. The coating of claim 1, comprising ytterbium monosilicate (Yb₂SiO₅) and ytterbium disilicate (Yb₂Si₂O₇).

11.-12. (canceled)

13. The coating of claim 1, wherein the rare earth disilicate to rare earth monosilicate weight ratio of the coating is at most about 95:5.

14. The coating of claim 1, having a biphasic structure in which rare earth monosilicate phases are dispersed a rare earth disilicate matrix.

15. (canceled)

16. The coating of claim 14, wherein the rare earth monosilicate phases have an average diameter of at most about 10 μm.

17.-21. (canceled)

22. The coating of claim 1, being free of pores interconnected together and forming through-thickness channels or through-thickness cavities.

23. (canceled)

24. The coating of claim 1, wherein the pores are uniformly dispersed in the coating.

25. The coating of claim 1, being free of through-thickness networks of interconnected microcracks.

26. (canceled)

27. The coating of claim 1, wherein the microcracks have a cross-section that is at most about 5 μm in its largest dimension.

28. (canceled)

29. (canceled)

30. The coating of claim 1, wherein microcracks in the coating heal when the coating is annealed.

31.-39. (canceled)

40. A method for the manufacture of the coating of claim 1, the method comprising:
a) heating the substrate to at least about 500° C., and
b) depositing the coating by atmospheric plasma spraying a coating precursor on the heated substrate,
wherein the coating precursor is rare earth disilicate particles, and wherein the atmospheric plasma spraying is performed with a plasma spray torch operated at an operating power of at least 60 kW.

41. The method of claim 40, wherein during step a), the substrate is heated to at least about 600° C.

42.-45. (canceled)

46. The method of claim 40, wherein the coating precursor is ytterbium disilicate particles.

47. The method of claim 40, wherein the coating precursor in injected in the plasma axially at the root of the plasma and at the center of a cross-section of the plasma.

48. The method of claim 40, wherein the atmospheric plasma spraying is performed at a stand-off distance of at most about 200 mm.

49.-58. (canceled)

59. The method of claim 40, further comprising the step c) of slowly cooling the substrate after step b).

60. (canceled)

61. The method of claim 59, wherein the substrate is cooled by gradually reducing the power of the plasma torch.

62. (canceled)

63. The method of claim 40, further comprising, after step b), and after step c) if step c) is present, annealing the coating.

64.-66. (canceled)
